(19) United States
(12) Patent Application Publication
(10) Pub. No.: US 2007/0271110 A1
(43) Pub. Date: Nov. 22, 2007

(54) Systems and methods to connect customers and marketers

(75) Inventors: Sean Van Der Linden, Berkeley, CA (US); Scott Faber, San Francisco, CA (US); Ron Hirson, San Francisco, CA (US); Ebbc Altberg, Mill Valley, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: UTBK, Inc.

(21) Appl. No.: 11/505,053

(22) Filed: Aug. 15, 2006

Related U.S. Application Data
(60) Provisional application No. 60/802,882, filed on May 22, 2006.

(51) Int. Cl. G06Q 10/00; G06Q 30/00

(52) U.S. Cl. 705/1

(57) ABSTRACT

Methods and systems for identifying, compensating and communicating with persons who have knowledge of, interest in, or experience with, products and/or services provided by an advertiser or marketer. One embodiment includes registering a plurality of customers who are interested in one or more products and services in a plurality of categories; providing information to one or more marketers to identify one or more of the customers having matching interest in the one or more products and services; and providing one or more communication channels to facilitate communications between one or more marketers and the one or more of the customers having matching interest in the one or more products and services.

This application claims the benefit of priority to U.S. Provisional Patent Application No. 60/802,882, filed May 22, 2006, entitled “System And Methods To Connect Marketing Participants And Marketers”, the disclosure of which is incorporated herein by reference.

### TECHNICAL FIELD

At least some embodiments of the present invention relate generally to providing a communication facility to allow the exchange of ideas and information and/or to facilitate commerce between advertisers and consumers.

### BACKGROUND

Advertisers and/or marketers are continuously seeking to connect with their customers or potential customers to promote their products and services and to obtain feedback and comments about their products and services. Conventionally, this has been done by inviting customers to attend live seminars in person and paying the customers for their time. Often the payment will take the form of a reward, such as receiving a gas grill for attending a seminar on time-share vacation homes. The customers become “participants,” as the advertisers ask them their opinions and questions as they sell them products ranging from encyclopedias to cars.

These live seminars achieve the full interactivity that advertisers seek with their customers. However, the problem with these seminars is the logistics involved with making the seminars happen. Potential participants are identified, selected and then invited to the seminar. The potential participants may have to travel to the location where the seminar is being held. Both the participants and the advertisers are in the same location at the same, pre-arranged time. The reward to attend the seminar, and the total attendance time required, are fixed and agreed to beforehand, so that it is worth the trouble of travel. Payments are also done manually, in accordance to the agreed reward. In summary, holding such live advertising seminars is quite difficult, and in many cases prohibitively expensive, because there is no simple system or mechanism for quickly and easily enabling them.

### SUMMARY

Methods and systems for identifying, compensating and communicating with persons (e.g., marketing participants) who have knowledge of, interest in, or experience with, products and/or services provided by an advertiser or marketer are described herein. One embodiment includes registering a plurality of customers who are interested in one or more products and services in a plurality of categories; providing information to one or more marketers to identify one or more of the customers having matching interest in the one or more products and services; and providing one or more communication channels to facilitate communications between one or more marketers and the one or more of the customers having matching interest in the one or more products and services. Other aspects are described below.

### BRIEF DESCRIPTION OF THE DRAWINGS

The present invention is illustrated by way of example and not by way of limitation in the figures of the accompanying drawings in which like references indicate similar elements, and in which:

FIG. 1 illustrates a block diagram illustrating a system to facilitate the exchange of ideas and information between consumers and advertisers, according to an embodiment of the present invention;

FIGS. 2-5 illustrate exemplary user interfaces for use with a system to facilitate the exchange of ideas and information between consumers and advertisers, according to an embodiment of the invention;

FIG. 6 illustrates an example of a method, according to an embodiment of the invention, for establishing a connection between an advertiser or marketer and a consumer;

FIG. 7 illustrates a block diagram of a data processing system, which can be used in embodiments of the invention.

### DETAILED DESCRIPTION

The following provides a detailed description of a method and system to facilitate sales and/or the exchange of ideas and information between advertisers and persons with knowledge of, interest in, or experience with, the advertiser's products and/or services. In the following description, for purposes of explanation, numerous specific details are set forth in order to provide a thorough understanding of the present invention. It will be evident to one skilled in the art, however, that the present invention may be practiced without these specific details. The description and representation herein are the means used by those experienced or skilled in the art to effectively convey the substance of their work to others skilled in the art. In some instances, to avoid unnecessarily obscuring tangential aspects of the present invention, well-known operations and components have not been described in detail.

Reference herein to “one embodiment” or “an embodiment” means that a particular feature, structure, operation, or other characteristic described in connection with the embodiment may be included in at least one implementation of the invention. However, the appearance of the phrase “in one embodiment” or “in an embodiment” in various places in the specification does not necessarily refer to the same embodiment.

In one embodiment, a registry is provided which can be used as a source of sales leads for sellers and/or telemarketers/telesales. People who are interested in, or in need of, particular types of services and/or products can register their interest or needs with the system. The registry provides a facility to allow the sellers or telemarketers to identify and communicate with their customers based on the specified needs of the customers. The registry service can also facilitate market research. For example, a company can solicit opinions from a targeted audience for a particular product or service either existing or envisioned and pays the subject for his/her time either per session or per unit of time.

People generally don't like to take unsolicited sales or marketing calls from companies because the products and services being offered are rarely relevant and the calls are intrusive. The impatience of the general population with the current telesales/telemarketing efforts leads to the implementation of the National Do Not Call Registry to limit unwanted telemarketing calls. Over 107 million people had signed up by the end of 2005.

In one embodiment of the present invention, a registry system allows people to specify their needs and/or interest in products and services, such that the products and services being offered are relevant. Further, the value of the time of the customers can also be considered. The customers can be compensated for their time and effort in communicating with the sellers, telemarketers or advertisers.

In one embodiment, a registry is provided where consumers can opt-in for specific types of marketing messages because they are actually in the market for particular products and/or services and would welcome relevant solicitation. Further, in one embodiment, the registry also allows the consumers to specify a value on their time in communicating the advertisers (such as sellers or telemarketers), if desired. Some consumers may choose to communicate with the advertisers for free to have information come to them. Some consumers may want to specify a price for communicating with them to limit the sellers to those having relevant products and services. Such a system has benefits to the telemarketers, too, since the telemarketers can identify consumers who have already indicated interest, and are thus much more highly qualified than a person found by random auto-dialing. The consumers may specify the value of their time in terms of a per call fee, a per minute fee, and/or a form of offer from the caller/seller, such as a percentage off the price of the seller's product or service. In one embodiment, a consumer can specify one or more criteria as the pre-condition to the receipt of a call/communication. Thus, the communications facilitated by the system have an improved rate in meeting the need of the consumers and telemarketers, while unwanted, irrelevant solicitations are reduced.

In one embodiment, the registry also provides a feedback and/or rating system which can be used to improve the reliability/usability of the system. For example, consumers may be rated such that the degree of trustworthy of their stated interest can be estimated by the sellers in selecting the consumers. For example, based on the rating of the consumers, sellers can determine whether a particular person is simply taking “for pay” calls to make money, or is really in the market. In one embodiment, a customer may be rated based on call history or statistical data, such as the number of calls they've taken, average call duration, and categories in which they are interested, the success rate of calls resulting in purchases, etc. Such information can be useful to a seller before calling. For example, based on conversion rates (e.g., converting from calls to purchases), sellers can determine whether it is worth calling someone who requires a specific price (e.g., per minute or per contact) for the call. The customers can also be rated based on feedback from the sellers. For example, after a telephone call facilitated by the system, a seller may provide a rating of the customer and/or comments on the customer. The rating specified by the seller can be a number (e.g., in the range of 0-5) or a letter (e.g., in the range of A-D). In one embodiment, after the system detecting that the conversation between the consumer and the seller ends, the system can prompt the seller to rate the consumer if the seller is connected to the system. Thus, the seller can simply remain on the line to provide the rating, after the system disconnects the consumer (or after the consumer hangs up). A seller may choose a certain minimum rating/performance indicator as a search criterion to select consumers. The seller may rate customers based on readiness for the market, willingness to provide feedback, etc.

In one embodiment, the advertisers (e.g., sellers or telemarketers) can also be rated by the consumers. For example, sellers may be rated based on call history or statistical data, such as the volume of calls, success rate of calls in making sales, etc. The sellers can also be rated based on feedbacks from the consumers. For example, the consumers may rate the sellers based on the products and/or services of the sellers, the attitude of the sellers, the willingness of the sellers to stay with the relevant product and service with the limit of the expressed interest of the consumer, etc. A buyer can choose a certain minimum rating/performance indicator as a precondition to accept contact.

In one embodiment, the system provides real time communication connections between the consumers and the advertisers (e.g., sellers or telemarketers), such as connections for telephone conversation, instant messaging, video conferencing, a multi-media channel for real time interaction (e.g., common whiteboarding, application sharing, etc.). Alternatively, or in combination, non-real time communications between the consumers and the advertisers can also be provided, such as email, short message service (SMS) message, etc. Other types of messaging system or media/communication system can also be used to facilitate the interaction between the consumers and the advertisers.

In one embodiment, a one-way transmission of information from the advertiser/seller to a customer/buyer is facilitated by the system to at least initiate the contact. The information can be transmitted via email, SMS message, or via voice mail, a video message, etc. The transmitted information may include an advertisement or offer from the advertiser/seller and a communication reference, which can be used by the customer/buyer to further request a real time communication connection, or send a response via a non-real time communication channel (e.g., email, SMS message, etc.) The communication reference may be used to request a real time communication connection for telephone conversation, for video conferencing, and/or for instant messaging, etc.

In one embodiment, the system may facilitate different types of communication channels between the advertisers and the customers. The customers may specify different prices for different types of communications (e.g., text, audio, video, real time, non-real time, etc.) The system may deduct a portion of the fees collected on behalf of the customers from advertisers as service charges. Alternatively or in combination, the system may separately charge the customers and/or the advertisers for facilitate the connections. Alternatively or in combination, the system delivers the advertisements for the advertisers (e.g., as voice message, text message, etc.) to initiate the contact; and the advertisers are charged based on the responses received from the customers (e.g., based on the real time communication leads generated via the advertisements).

In one embodiment, the system facilitates the communications between a advertiser/seller and a customer/buyer via separate channels with the advertiser/seller and the customer/buyer and relaying the transmitted information. The contact information of the customer/buyer is not revealed by the system to the advertiser/seller and the direct contact of the advertiser/seller is not revealed by the system to the customer/buyer.

In one embodiment, the system allows customers/buyers to specify a time expiration on their interest, if they desire. The system will not connect advertisers/sellers to the customers/buyers after the time limits specified by the customers/buyers. For example, some customers may want to purchase items before Christmas, before back to school, before a birthday, etc. Thus, their interest can be registered with the system with the corresponding time limits, beyond which the interest expires.

In one example, a customer is currently in the market for home shop equipment, and an electrician to wire it up. In one embodiment, the customer can create a personal profile with the registry system and then choose the categories in the marketplace where the customer is willing to be marketed to and/or polled for market research. In the categories chosen by the customer, the profile can be enhanced to describe the appropriate needs. Businesses or individuals who are looking to market matching products/services can find the customer using the registry system and contact the customer according to the price set by the customer for the time and effort of the customer in communicating with the sellers/advertisers. The customer may set a fixed price, or a zero price, or a relative price (e.g., based on the price of the products and/or services offered by the sellers). For example, the customer may set a zero price but request a specific discount if the customer accepts an offer from a seller over the phone. In one embodiment, sellers who subscribe to the corresponding categories of the registry system can get an automated notification of the customer interest (e.g., via email, instant messages, or other messaging system). In one embodiment, a subscribed category can be specified using a set of search criteria. Alternatively, or in combination, the sellers may use a web-based interface to search the registry system for leads to interested customers.

In one embodiment, the registry system encourages or, in certain implementations or circumstances, requires that sellers offer some sort of incentive to buyers if they close business on the initial contact, or on follow-up contacts initiated through the system by sellers (or buyers). Such incentive may be in combination with the prices and/or other requests specified by the individual buyers.

In one embodiment of the invention, a system facilitates a method to connect an advertiser with persons (referred to herein as customers) who are interested in products and/or services provided by the advertiser. The system may be client-server based with a web-based interface (or a telephone interface via an interactive voice response (IVR) system, or an email/IM/SMS gateway system). In one embodiment, the system includes clients executing conventional web browser applications in communication with one or more servers executing a web server application. In addition, the server component may be communicatively coupled to a communications interface that manages communication sessions between participants of the system. For example, under the direction of the server component, the communications interface may establish a telephonic communication session between an advertiser and a potential customer.

According to one embodiment of the invention, participants of the system are generally categorized into one of two roles—advertisers/marketers and customers. As such, an advertiser/marketer is a participant that has a product or service to be promoted or sold, and is seeking promotion of the product or service and/or information about the product or service from customers that have either used the product or service, or sale of the product or service, or are interested in learning about or buying the product or service.

In one embodiment of the invention, both customers and advertisers can register with the system via a web-based interface, by creating a member name/username and providing user information, including contact information. During the registration process, or anytime thereafter, customers may be prompted to specify areas or categories of interest, or possibly even particular products or services, for which they are willing to discuss their experience or interest with an advertiser or provider of products or services, or listening to the advertisement or sales offer from the advertiser or marketer. Alternatively, registration can be performed over other types of communication channels, such as telephone, instant messaging, etc.

Accordingly, once registered, an advertiser/marketer can search a database of user information to identify customers that are willing to discuss particular products or services, or categories of products or services. For example, in response to a query submitted by an advertiser, the system may display a selectable representation (e.g., hyperlink) of one or more customers that satisfy the query. By selecting a representation of a particular customer, the advertiser can establish a connection with the customer. For example, in one embodiment of the invention, a selectable representation of a customer includes an identifier of the customer, such that, when selected, a process is started to connect the advertiser and the customer, without providing the customer's contact information to the advertiser.

Furthermore, in one embodiment of the invention, the system provides a mechanism for the advertiser to compensate customers for their time, and for the exchange of ideas and information. For example, during the initial registration process, or after a customer has registered, the system allows the customer to enter or select a proposed fee or rate, such as a dollar amount per unit of time (e.g., $1.00 per minute or $10 per call). Accordingly, when a customer's user information satisfies an advertiser's query, the customer's fee information may be displayed to the advertiser along with the selectable representation of the customer. Consequently, an advertiser is provided not only with a list of customers that have indicated an interest in a particular product or product category, but also rate information for each customer. After the communications interface establishes a connection between a particular customer and the advertiser, the communications interface monitors or tracks the duration of the session in order to determine the fees charged to the advertiser and credited to the customers. Moreover, in one embodiment of the invention, the system manages the billing and payment aspects of each transaction (e.g., paid communication session). In one embodiment, the system deducts a portion of the fees charged by the customers as fees to advertise the customers and/or provide the connection service. In one embodiment, the system deducts a pre-determined percentage of the fees charged by the customers. Alternatively, a flat fee for each connection or a monthly or yearly fee can be charged for the service of the system.

Alternatively, the system charges the customer and/or the advertiser a predetermined fee per communication connection that is provided to the customer and the advertiser. Further, the customers and/or the advertisers may specify their respective predetermined fees that are charged by the system if the communication connections are provided.

In one embodiment, during the period of the communication connection provided by the system, the customer is allowed to purchase from the advertiser. The system tracks the purchase made by the customer, deduct from or credit to corresponding accounts of the customer and advertiser for the amount that is agreed upon during the purchase process. In one embodiment, the product and/or service of the advertiser is delivered via the communication connection provided by the system. Alternatively, the system receives the product from the advertiser and forwards/presents the product to the consumer to avoid revealing the contact information of the consumer to the advertiser and to protect the privacy of the consumer.

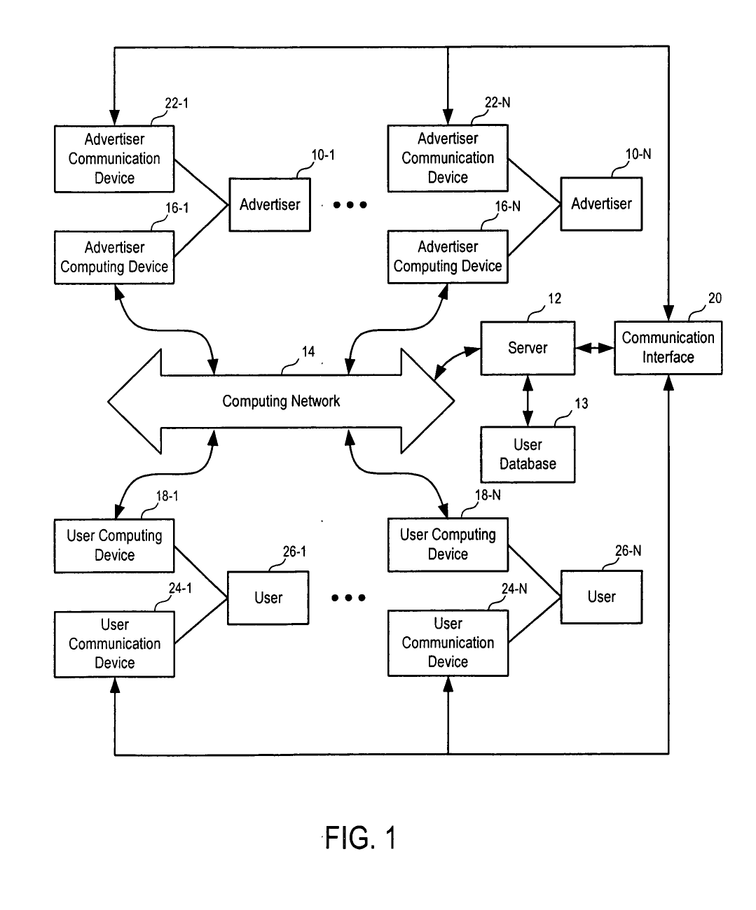

FIG. 1 illustrates a block diagram of a system to facilitate the exchange of ideas and information between consumers and advertisers, according to an embodiment of the present invention. As illustrated in FIG. 1, the system includes a server 12 including a user database 13, coupled by means of a network 14 to one or more client computing devices (e.g., advertiser computing devices 16-1 through 16-N, and user computing devices 18-1 through 18-N.) In addition, the system includes a communications interface 20 for establishing and managing communication sessions (e.g., such as telephonic communications) between system participant's communication devices (e.g., advertiser communication devices 22-1 through 22-N, and user communication devices 24-1 through 24-N). The advertisers (e.g., 10-1 through 10-N) and the users (e.g., 26-1 through 26-N) can communicate with each other through the use of the server 12 and the communication interface 20.

The network 14, over which the server 12 and clients 16-1 and 24-1 communicate, may be a local area network (LAN), wide area network (WAN), or any similar technology that enables data exchange between the server 12 and the computing devices 16-1 and 18-1. In addition to a data network 14, in one embodiment of the invention, the communications interface 20 utilizes a separate communications network (not explicitly shown in FIG. 1), such as a public switched telephone network, to establish connections between communication devices 22-1 and 24-1. In one embodiment of the invention, the communications interface 20 may be, or include, a telephone switching device. Accordingly, in one embodiment of the invention, an advertiser communication device 22 and/or a user communication device 24 may be a conventional telephone (e.g., landline or mobile).

In an alternative embodiment of the invention, a computing device (e.g, advertiser computing device 16-1) and a communication device (e.g., advertiser communication device 22-1) may be integrated as one device. Furthermore, it will be appreciated by those skilled in the art that the network 14 may be utilized for both data and communication session. For example, in one embodiment of the invention, communication sessions may be established over the network 14 utilizing VOIP-based technology (Voice over Internet Protocol). In addition, in alternative embodiments, other means of communication may be utilized to establish communication sessions. For example, in one embodiment of the invention, advertisers and customers may communicate via IP-based video conferencing or instant messaging networks. In one embodiment, the communication interface 20 is part of the server 12.

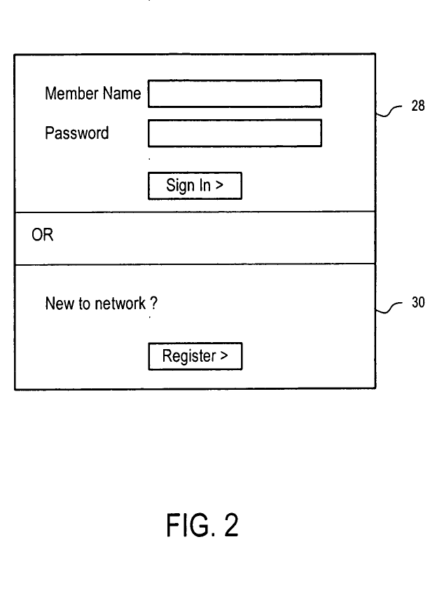

FIG. 2 illustrates an example user interface that may be utilized in a system, according to an embodiment of the invention, for establishing a user account with the system. The user interface illustrated in FIG. 2 can be provided in the form of a web page, which may be served by a web server (e.g., executing on the server 12) and viewed in a client's web browser (e.g., executing on user computing device 18-1 or advertiser computing device 16-1) in a conventional manner. According to one embodiment of the invention, if a user has already registered with the system, the user may enter his or her user credentials and login to the system using the portion 28 of the interface. However, when a user first interacts with the system, the user is allowed to register with the system as a member. For example, by manipulating a cursor device to select a “register” button in the portion 30 of the interface, a user can start a process to register with the system as a member. In one embodiment, both the advertisers and customers can register as members. Alternatively, different advertisers and customers may be registered and signed in differently (e.g., via different user interfaces or web pages). In one embodiment, advertisers are not required to sign in to search the listings of customers who are willing to talk to the advertisers; and the advertisers are authenticated before they are connected to the customers.

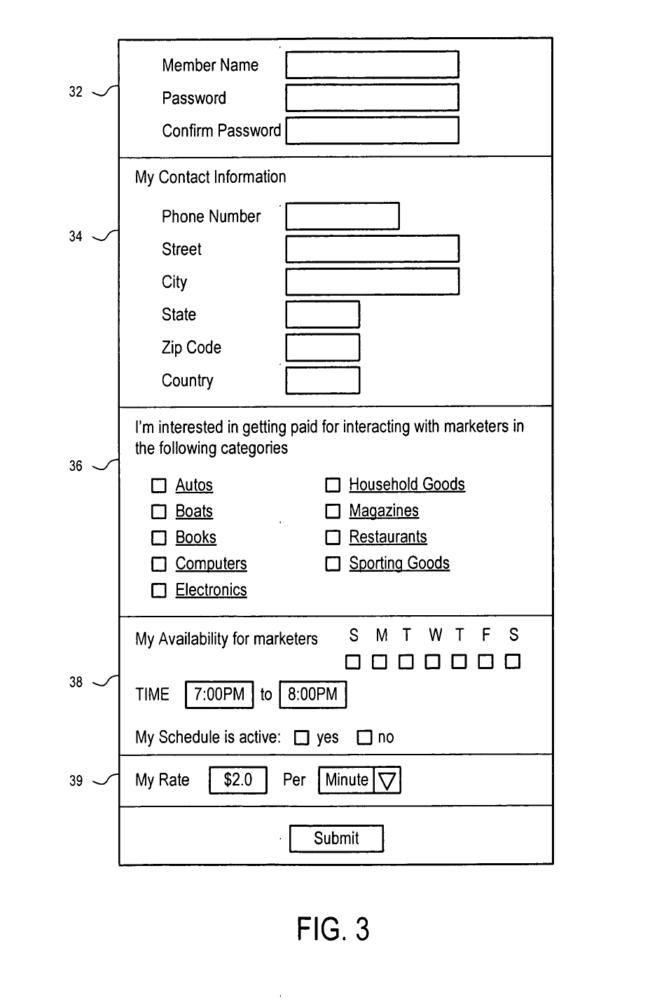

After a user has selected to register as a customer, for example, by selecting the “register” button in the portion 30 of the interface, the system may prompt the user/customer to enter personal or user information. For example, the system displays a web page such as that illustrated in FIG. 3. Accordingly, in addition to selecting a member name (username) and password in section 32, the customer is prompted to enter contact information in section 34, such as a residential address, telephone number, and optionally other information such as instant messaging service and username, etc.

In one embodiment, the customer can also update the various user information after subsequently signing in as a registered member.

In one embodiment, the customer is allowed to select one or more areas, categories or items of interest in section 36, for which the user is willing to provide information to an advertiser or marketing person or listen to the advertisements. In one embodiment, the advertisements can be partially or entirely pre-recorded, and/or be partially or entirely provided by a live advertiser/marketer. In one embodiment, the user is further allowed to specify more specific information for the areas, categories or items listed in section 36. For example, following a hyperlink at the corresponding item, a user may further specify a detailed description that may be interesting to a marketer.

The user is allowed specify the availability schedule for the marketers in section 38. For example, the user may specify the days of a week the user is willing to be contacted by the advertisers via real time communication channels, such as telephone, instant messaging, etc. The user may specify the time period within a day during which the user is available for marketers. The user may specify whether the schedule is active or not. When the schedule is not active, the system will not connect marketers to the user; and the system will not connect marketers to the user in a time period that is not in the user specified availability schedule. Thus, the user has the control on when the marketers can be connected to the user via the system. In one embodiment, the user is allowed to specify one or more available time periods for a day; and in one embodiment, the user is allowed to specify different time periods for different days of a week. In one embodiment, the user is allowed to specify the availability based on a calendar.

The user is allowed to specify the rate in section 39. The system will charge the advertiser/marketer according to the rate specified by the user for the time of the user spent in interacting with the advertiser/marketer.

Thus, users are allowed to register their interest and consent to be contacted by the marketers, together with their respective conditions and limitations, such that the system will connect the qualified advertisers to the users at the convenience of the users.

In one embodiment, a user is allowed to further register with the system as an advisor who is willing to talk to others for a fee. The fee can be the same as the rate specified in the section 39. Alternatively, a different rate can be specified for charging others who want to talk to the user. The user may provide a description of expertise, experience, qualifications, etc. such that others may find the user through an online search or through advertisements made by the system for the user. For example, the system may provide the user with a telephone number, with or without extension. When the telephone number is called, the phone call reaches the system; and the system looks up the phone number of the user based on the telephone number dialed to reach the system and connects the caller to the user. The telephone number can be included in advertisements provided by the system on behalf of the user, or be included in other content, such as a personal web site of the user, a blog maintained by the user, a business card of the user, etc. In one embodiment, a hyperlink (or a selectable icon, such as a button) can also be assigned to the user, for the inclusion in an advertisement or other content. In one embodiment, the user may also register with the system so that the system provides advertisements for the user on topics related or unrelated to the area, items, categories listed in the section 36 of the interface.

It will be appreciated by those skilled in the art that various embodiments of the invention may have user interfaces that differ from that which is illustrated in FIG. 3 without departing from the spirit of the present invention. For example, in one embodiment of the invention, several web pages may be utilized to prompt for, and collect, the items of information shown in FIG. 3. In addition, FIG. 3 specifically shows broad category designations (e.g., autos, boats, etc.) for indicating areas of interest. In alternative embodiments of the invention, the system may enable the selection of individual products or services. Moreover, the categories and/or items may be organized in a hierarchical structure, such that a customer first indicates a main category, and is then presented with sub-categories or items within the main category. Moreover, in one embodiment, the list of items from which the customer is to select may be based on products or services that have been registered with the system by one or more advertisers or marketers. This ensures that the customer does not indicate a preference to share information associated with a category or product for which no advertisers are seeking information.

Although FIG. 3 illustrates a single form for indicating customer availability and rate/fee information, in alternative embodiments, the availability and rate/fee information may be selectable on a per item or per category basis. That is, the customer may customize his selections by selecting different rates and availability for each category and/or item. For example, a customer may select a high fee for an item or category for which the user has significant experience with. Alternatively, the customer may specify a high rate for areas of less interest to the customer.

Furthermore, in an alternative embodiment of the invention, the customer may be able to establish or modify a fee during a communication session with an advertiser. For example, in one embodiment of the invention, a customer may utilize a telephone dial pad, or keyboard, to establish a rate at the time a communication session (e.g., telephone call, instant messaging session, video conferencing session, etc.) is being established.

In one embodiment, the information collected about the user is stored in the user database 13 (shown in FIG. 1).

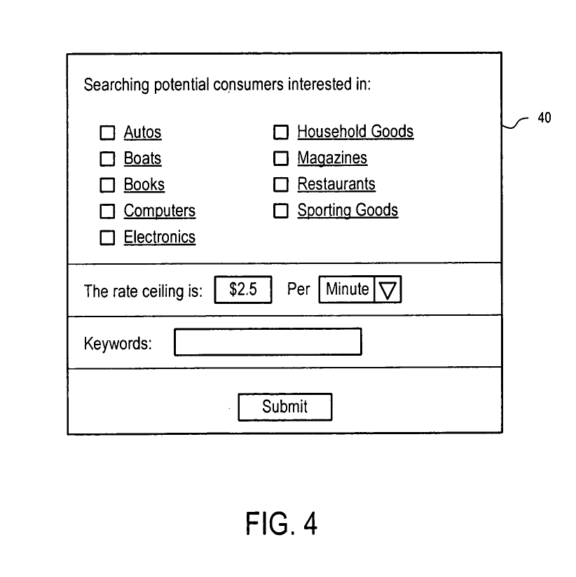

FIG. 4 illustrates an example user interface 40 that may be presented to an advertiser or marketer. The user interface 40 can be presented as a web page to allow the advertiser to select one or more categories corresponding to categories that customers have expressed interest in discussing. The advertiser is allowed to specify other search criteria, such as a rate ceiling to find users whose request compensation rates are lower than or equal to the rate ceiling, keywords to find users who provide a description that contains the keywords, etc.

Accordingly, the system enables the advertiser to generate a query that is executed against user information stored in a user database 13. As illustrated in FIG. 4, the query may be generated by means of a graphical user interface.

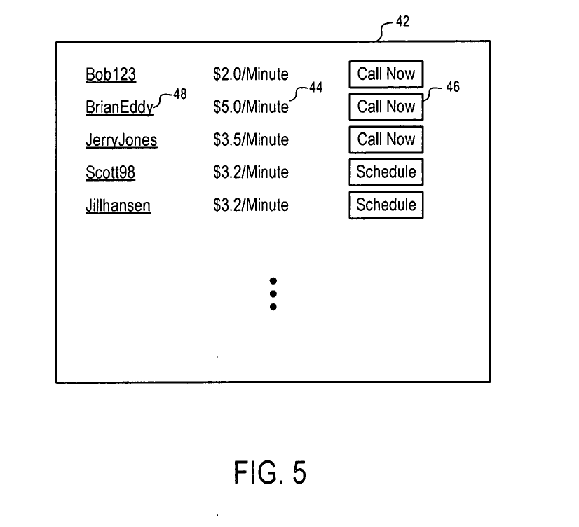

After the query is executed, the system returns the results of the query (e.g., in a web page), such as that illustrated in FIG. 5. In FIG. 5, a list 42 of customers is displayed. Accordingly, the list 42 of customers represents those customers/users who have indicated an interest in listening to the advertisers/marketers, and/or sharing ideas and information, or learning about, a particular category of products or a specific product. In one embodiment of the invention, the customer list includes information about each customer's rate information 44, connection or communication method 46, and current availability.

For example, when the customer on the list is currently available for marketers, a “call now” button can be used to request a telephone connection with the customer. When the “call now” button is selected, the system determines a phone number of the advertiser. For example, a further web page can be presented to ask the advertiser to provide a telephone number so that the system can call back the advertiser. If the advertiser has already signed in the system, the system can look up a phone number of the advertiser from information the system maintained for the advertiser; based on the preference of the advertiser, the system calls back the advertiser on a phone number of the advertiser, or allow the advertiser to further specify a call back telephone number.

Alternatively, the advertiser may call the system at a phone number, and provide an extension that is assigned to the customer to instruct the system to provide a connection to the customer. In response to the extension, the system looks up the telephone number of the customer, makes a separate telephone call to the customer, and joins the customer and the advertiser when both the customer and the advertiser are on phone lines.

When the customer on the list is current unavailable for marketers, a “schedule” button can be used to request a future telephone connection with the customer. At the scheduled time, the system attempts to call both the customer and the advertiser and connects them when they are both available. Alternatively or in combination, customer names may be presented with a special icon, or in different font (e.g., bold face), when the particular customer is presently available for a communication session.

In one embodiment, when a customer can be reached via multiple types of communication links, such as telephone, instant messaging, etc., different icons corresponding to different types of links can be presented on the list. Alternatively, one icon is presented, which when selected causes the system to further provide options to select a specific type of communication link to teach the customer. Alternatively, when available, the system may connect the customer and the advertiser via multiple types of communication links, such as telephone, instant messaging, video conferencing, etc.

Furthermore, the representation of each customer may be a link or hyperlink that, when selected, provides further information about the customer, or causes a connection between the customer and the advertiser to be established.

In one embodiment, when a connection to the customer is selected by an advertiser/marketer, the advertiser/marketer is authenticated before the system connects the advertiser/marketer to the customer. The advertiser can sign into the system through a web interface, or through providing authentication information via the communication link requested. The system can make separate connections to the advertiser and the customer and then join/conference the connections to prevent the leak of the direct contact information of the customer to the advertiser.

In one embodiment, the system presents communication references that are assigned to the customers, such as telephone numbers (with or without extensions), instant messaging user IDs, VoIP user IDs, etc. The communication references can be used to make a real time communication connection to the system, which then uses the association relation between the communication references and the corresponding customers to look up the corresponding communication contacts of the customers.

In one embodiment, the system automatically contacts the marketer (via email, telephone, SMS, IM, etc.) when new customers with the appropriate, matching profile (e.g. the right product category, point in purchase cycle, and/or demographic profile, etc.) enter the system.

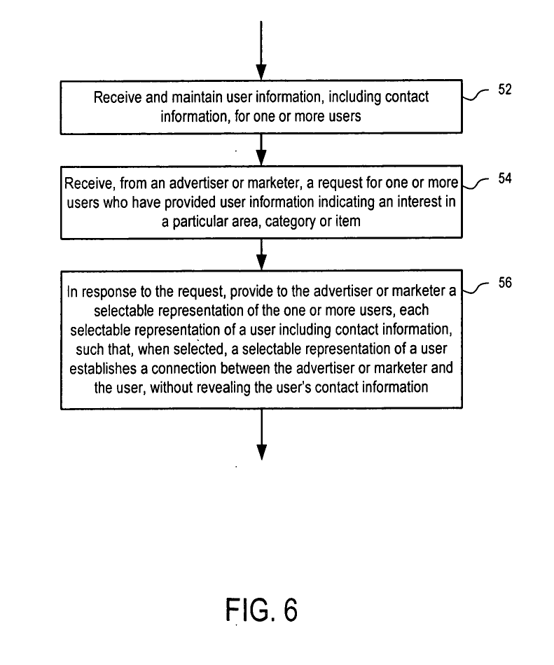

FIG. 6 illustrates a method, according to an embodiment of the invention, for establishing a connection between an advertiser and a customer, for the purpose of exchanging information and ideas related to a category of products. At operation 52, user information is received (e.g., at server 12). For example, the user information may include categories of products, or specific products about which the user is interested in speaking with an advertiser. In addition, the user information will typically include contact information, indicating a means for establishing a communication session with an advertiser, rate or fee information, and availability information, indicating times when the user is available to communicate with an advertiser. Once the user information is received, it is stored (e.g., on user database 13), where it can later be queried. At operation 54, a request for one or more customers/users with an interest in discussing a particular category of products is received from an advertiser. For example, the request may be, or include, a query, indicating a particular product or service, or a category of product or service.

Next, at operation 56, in response to the request, the server 12 provides to the advertiser a representation (e.g., hyperlink) of one or more users, who have indicated an interest in exchanging ideas and/or information about the particular product, or category of products specified by the advertiser in operation 54. In one embodiment of the invention, a representation of a user may be a selectable hyperlink, which, when selected, causes a connection to be established between the advertiser (who selected the link), and the customer/user who is represented by or associated with the link.

In one embodiment of the invention, the system facilitates establishing communication sessions while preserving the privacy of both parties. For example, an advertiser may be able to establish a communication session with a customer, without the system providing the advertiser with the customer's contact or personal information. In one embodiment of the invention, this is achieved by providing a code with the representation of the user displayed in the customer list presented to the advertiser. When the advertiser selects a particular customer from the list, the code is communicated to the system, and the server 12 looks up a customer associated with the code.

In one embodiment of the invention, communications sessions are established via the communications interface 20, which may be a telecommunications switch, private branch exchange, media server, or other like device. Accordingly, upon receiving a customer selection from an advertiser (e.g., selected from the list 42 of FIG. 5), the server 12 may direct the communications interface 20 to establish a communications session between the advertiser and the selected customer. For example, the server 12 may pass contact information to the communications interface 20 for both the customer, and the advertiser. In addition, the communications interface 20 may monitor the communication session for purposes of determining the duration of the session for billing purposes.

In one embodiment, the server initiates VoIP telephone calls to connect to the advertisers and/or the customer via one or more telephone carriers, which can further route the VolP telephone calls to telephones which may be connected to a public switched telephone network.

From this description, it will be appreciated that certain aspects of the invention are embodied in the advertiser and user devices (e.g., 16-1 and 24-1 in FIG. 1), certain aspects of the invention are embodied in the server system(s), and certain aspects of the invention are embodied in a system as a whole, including the communications interface. Embodiments of the present invention can be implemented using hardware, programs of instruction, or combinations of hardware and programs of instructions. In one embodiment of the invention, the system described herein may be a component or part of a greater system. In particular, the present invention may be combined with an advertising server or another server, such as that described in related U.S. patent application Ser. No. 808,475 filed on Mar. 13, 2001, entitled, “Apparatus and Method for Recruiting, Communicating with, and Paying Participants of Interactive Advertising.”

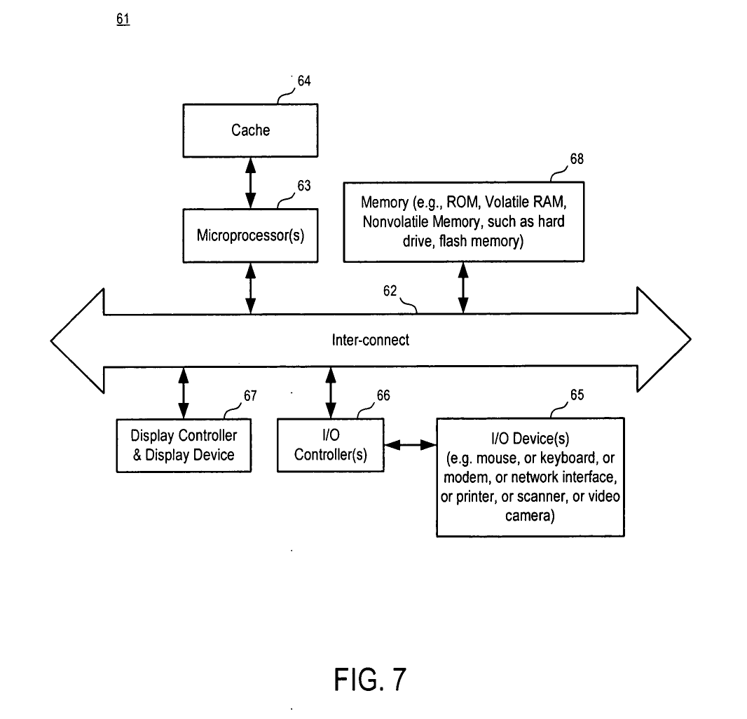

FIG. 7 shows a block diagram example of a data processing system which may be used with the present invention.

While FIG. 7 illustrates various components of a computer system, it is not intended to represent any particular architecture or manner of interconnecting the components. Other systems that have fewer or more components may also be used with the present invention.

In FIG. 7, the system (61) is a form of a data processing system. The system (61) includes an inter-connect (62) (e.g., bus and system core logic), which interconnects a one or more microprocessors (63) and memory (68). The microprocessor (63) is coupled to cache memory (64) in the example of FIG. 7.

The inter-connect (62) interconnects the microprocessor(s) (63) and the memory (68) together and also interconnects them to a display controller and display device (67) and to peripheral devices such as input/output (I/O) devices (65) through an input/output controller(s) (66). Typical I/O devices include mice, keyboards, modems, network interfaces, printers, scanners, video cameras and other devices which are well known in the art.

The inter-connect (62) may include one or more buses connected to one another through various bridges, controllers and/or adapters. In one embodiment the I/O controller (66) includes a USB (Universal Serial Bus) adapter for controlling USB peripherals, and/or an IEEE-1394 bus adapter for controlling IEEE-1394 peripherals.

The memory (68) may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a server data processing system as illustrated in FIG. 7 is used as one of the communication server(s) (e.g., 12, 13 and/or 20 in FIG. 1).

Further, a user terminal as a computing device or communication device can be a data processing system similar to the system of FIG. 7. A client system can be in the form of a PDA, a cellular phone, a notebook computer or a personal desktop computer. For example, the I/O devices of the user device may include a USB phone, a Bluetooth wireless phone, or one or more speakers or headphones with one or microphones for the implementation of a software based phone.

Alternatively, the traditional communication client(s) may be used in some embodiments of the present invention.

In general, routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention.

While some embodiments of the invention have been described in the context of fully functioning computers and computer systems, those skilled in the art will appreciate that various embodiments of the invention are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods of the present invention. The executable software and data may be stored in various places including for example ROM, volatile RAM, non-volatile memory and/or cache. Portions of this software and/or data may be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the present invention. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
registering a plurality of customers who are interested in one or more products and services in a plurality of categories;
providing information to one or more marketers to identify one or more of the customers having matching interest in the one or more products and services; and
providing one or more communication channels to facilitate communications between one or more marketers and the one or more of the customers having matching interest in the one or more products and services.

2. The method of claim 1, wherein said registering the plurality of customers comprises:
registering a customer with one or more criteria for marketers as a pre-condition for the customer being contacted.

3. The method of claim 2, wherein the one or more criteria include a time limit for initiation of contact.

4. The method of claim 2, wherein the one or more criteria include a compensation request for engaging in communication with marketers.

5. The method of claim 2, wherein the one or more criteria include a schedule within which initiation of real time communication contact with the customer is to be limited to.

6. The method of claim 2, wherein the one or more criteria include a requirement according to a rating indicator of marketers based on customer feedbacks.

7. The method of claim 2, wherein the one or more criteria include a requirement based on statistical data on prior communications with customers.

8. The method of claim 4, wherein the compensation is based on a time duration of a communication session.

9. The method of claim 4, wherein the compensation is based on initiation of a communication session.

10. The method of claim 2, wherein the one or more criteria include a request for a discount off a product or service marketed.

11. The method of claim 1, wherein said providing the information to the one or more marketers comprises:
notifying a marketer in response to one of the customers registering interest in one or more products and services matching one or more selecting criteria of the marketer.

12. The method of claim 11, wherein said notifying comprises notifying the marketer via email, short message service (SMS) message, voice mail, instant messaging, or telephone call.

13. The method of claim 1, said providing the information to the one or more marketers comprises:
providing the information in response to a search request from the one or more marketers.

14. The method of claim 1, wherein the one or more communication channels comprise at least one of a telephone connection, an instant messaging connection, a video conference connection, a multi-media connection, email, voice mail, and text message.

15. The method of claim 1, further comprising at least one of:
prompting a customer to rate a marketer; and
prompting a marketer to rate a customer.

16. The method of claim 1, wherein said providing one or more communication channels comprises:
delivering an advertisement to the one or more of the customers on behalf of a marketer, the advertisement including a communication reference usable to request a real time communication connection with the marketer.

17. The method of claim 1, wherein said providing information to the one or more marketers comprises:
providing one or more communication references corresponding to the one or more of the customers, the one or more communication references usable to request real time communication connections to the one or more of the customers.

18. The method of claim 17, wherein said providing one or more communication channels comprises:
communicating with a customer using a first communication channel;
communicating with a marketer using a second communication channel separate from the first communication channel; and
relaying communications between the first and second communication channels to facilitate communications between the customer and the marketer.

19. A machine readable media embodying instructions, the instructions causing a machine to perform a method, the method comprising:
registering a plurality of customers who are interested in one or more products and services in a plurality of categories;
providing information to one or more marketers to identify one or more of the customers having matching interest in the one or more products and services; and
providing one or more communication channels to facilitate communications between one or more marketers and the one or more of the customers having matching interest in the one or more products and services.

20. A data processing system, comprising:
means for registering a plurality of customers who are interested in one or more products and services in a plurality of categories;
means for providing information to one or more marketers to identify one or more of the customers having matching interest in the one or more products and services; and
means for providing one or more communication channels to facilitate communications between one or more marketers and the one or more of the customers having matching interest in the one or more products and services.
